(19) United States
(12) Patent Application Publication
(10) Pub. No.: US 2021/0383282 A1
(43) Pub. Date: Dec. 9, 2021

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Kengo TOKUCHI, Kanagawa (JP)

(73) Assignee: FUJIFILM BUSINESS INNOVATION CORP., Tokyo (JP)

(21) Appl. No.: 17/073,555

(22) Filed: Oct. 19, 2020

(30) Foreign Application Priority Data
Jun. 5, 2020 (JP) 2020-098676

(51) Int. Cl. G06Q 10/02; G06Q 10/10; G06Q 30/00; G06Q 10/06; G06Q 50/00; G06Q 30/06

(52) U.S. Cl. CPC G06Q 10/02; G06Q 10/109; G06Q 30/0645; G06Q 10/06314; G06Q 50/01; G06Q 30/0185

(57) ABSTRACT

An information processing apparatus includes a processor configured to output, in the case where a person who has a reservation of a location and a person who has a reservation of a service to be used at the location do not match each other, information indicating that such reserving persons do not match each other.

### CROSS-REFERENCE TO RELATED APPLICATIONS

This application is based on and claims priority under 35 USC 119 from Japanese Patent Application No. 2020-098676 filed Jun. 5, 2020.

### BACKGROUND

### (i) Technical Field

The present disclosure relates to an information processing apparatus and a non-transitory computer readable medium.

### (ii) Related Art

Japanese Unexamined Patent Application Publication No. 2018-055480 describes a device that receives a condition for providing a service, divides the received condition into a plurality of conditions, and acquires information about a service provider that meets each of the divided conditions.

### SUMMARY

It is conceivable that a reservation is made for a location and a service to be used at the location. In this case, there may be an occasion in which a person who has a reservation of the location and a person who has a reservation of the service do not match each other.

Aspects of non-limiting embodiments of the present disclosure relate to resolving a situation in which a person who has a reservation of a location and a person who has a reservation of a service to be used at the location do not match each other.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to output, in a case where a person who has a reservation of a location and a person who has a reservation of a service to be used at the location do not match each other, information indicating that such reserving persons do not match each other.

### BRIEF DESCRIPTION OF THE DRAWINGS

An exemplary embodiment of the present disclosure will be described in detail based on the following figures, wherein:

FIG. 1 is a block diagram illustrating the configuration of an information processing system according to the present exemplary embodiment;

FIG. 2 is a block diagram illustrating the configuration of a location reservation management device;

FIG. 3 is a block diagram illustrating the configuration of a service reservation management device;

FIG. 4 is a block diagram illustrating the configuration of a reservation management device;

FIG. 5 is a block diagram illustrating the configuration of a terminal apparatus;

FIG. 6 illustrates a location reservation management table and a service reservation management table;

FIG. 7 illustrates a screen;

FIG. 8 illustrates a screen;

FIG. 9 illustrates a location reservation management table and a service reservation management table; and

FIG. 10 illustrates location reservation management tables and a service reservation management table.

### DETAILED DESCRIPTION

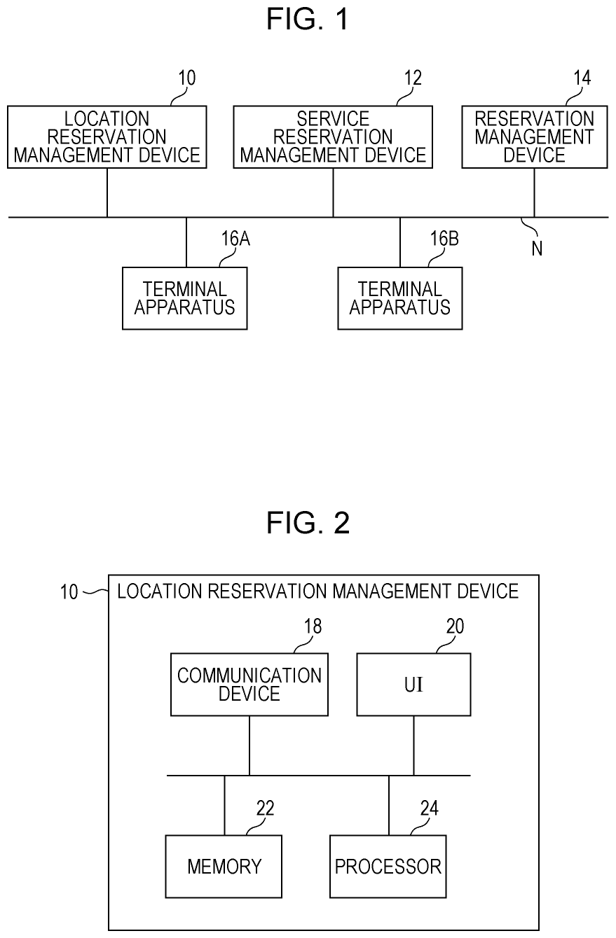

An information processing system according to the present exemplary embodiment will be described with reference to FIG. 1. FIG. 1 illustrates an example of the configuration of the information processing system according to the present exemplary embodiment.

The information processing system according to the present exemplary embodiment includes a location reservation management device 10, a service reservation management device 12, a reservation management device 14, and one or more terminal apparatuses (e.g. terminal apparatuses 16A and 16B).

The location reservation management device 10, the service reservation management device 12, and the reservation management device 14 may be separate devices or systems, or may be constituted of one device or system. For example, the reservation management device 14 may include the location reservation management device 10 and the service reservation management device 12. The number of terminal apparatuses illustrated in FIG. 1 is merely exemplary. In the following description, the terminal apparatuses will be referred to as “terminal apparatuses 16” in the case where it is not necessary to distinguish the individual terminal apparatuses.

The devices included in the information processing system according to the present exemplary embodiment have a function of communicating with a different device. The communication may be made through wired communication in which a cable is used, or may be made through wireless communication. That is, the devices may be physically connected to a different device through a cable to transmit and receive information to and from each other, or may transmit and receive information to and from each other through wireless communication. Examples of the wireless communication include near-field wireless communication and Wi-Fi (registered trademark). Wireless communication of a different standard may also be used. Examples of the near-field wireless communication include Bluetooth (registered trademark), Radio Frequency Identifier (RFID), and Near Field Communication (NFC). The devices may communicate with a different device via a communication path N such as a Local Area Network (LAN) and the Internet, for example.

The information processing system according to the present exemplary embodiment provides a location to a user, and allows the user to use the location. For example, the location is lent to the user for a charge or for free. In addition, the information processing system provides a service to be used at the location to the user, and allows the user to use the service at the location. For example, the service is available to the user for a charge or for free.

The location may be a closed space, or may be an open space. Examples of the location include a booth, a meeting room, a shared room, an office such as a shared office, a classroom, a store, an open space, and other defined spaces. The location may be lockable with electronic locking etc. to be lent to the user.

Providing the service includes providing a tangible object (e.g. a physical object such as an instrument), an intangible object (e.g. information, electricity, light, heat, software, etc.), etc. The content of the service is not specifically limited. The service may be a service assumed to be used by individual users, or may be a service assumed to be shared by a plurality of users.

The instrument is not specifically limited. Examples of the instrument include a device, a tool, a stationery item, a writing instrument, a household item, a cooking utensil, a sports instrument, a medical instrument, a farming tool, a fishing tool, and an experimental instrument. Examples of the device include a personal computer (hereinafter referred to as a “PC”), a tablet PC, a smartphone, a cellular phone, a robot (such as a humanoid robot, a non-humanoid animal-like robot, and other robots), a printer, a scanner, a multi-function device, a projector, a display device such as a liquid crystal display, a recording device, a playback device, an imaging device such as a camera, a refrigerator, a rice cooker, a microwave oven, a coffee maker, a vacuum cleaner, a washing machine, an air conditioner, lighting equipment, a clock, a monitoring camera, an automobile, a two-wheeled vehicle, an aircraft (e.g. an unmanned aircraft (a so-called drone)), a gaming device, and various sensing devices (e.g. a temperature sensor, a humidity sensor, a voltage sensor, a current sensor, etc.). The device may be an information device, a visual device, or an audio device.

The software is not specifically limited, and may be an application program, an operating system (OS), etc. The software may be provided via the Internet, or may be installed in a PC etc. In addition, data such as image data, document data, voice data, and music data may be provided as the service.

The service may be a service that provides a virtual desktop infrastructure (VDI), a service that provides television (TV) conferencing, a web service, etc. Examples of the web service include a service that provides online conferencing or web conferencing, and a service that provides an application on a network such as the Internet. Examples of the web service include web learning (e.g. learning of English conversation etc.), web-based training (WBT), web mail, a social networking service (SNS), a service that provides movies or music on the Internet, a service that sells or receives a reservation of a product on the Internet, a service that allows a search on the Internet, and a service that provides information on the Internet.

The location reservation management device 10 is configured to manage reservations of locations. For example, in the case where a user reserves a location, the user who has reserved the location is permitted to use the reserved location. For example, in the case where a user reserves a location with designation of a time for which use of the location is allowed, the user is permitted to use the reserved location during the time. The time is defined by the date and the time slot, for example.

The location reservation management device 10 manages location identification information for identifying the reserved location, location reserving person identification information for identifying the user who has reserved the location (i.e. the reserving person of the location), and location reservation time information that indicates the time for which the location is to be used (i.e. the location reservation time) in connection with each location, for example. The location reservation management device 10 generates location reservation management information for managing such connection, and stores the location reservation management information. The location reserving person identification information includes the name of the user, the user ID, the user account, etc. The location reservation time information indicates the date and time, the time slot, etc. For example, a user is able to reserve a location by operating the terminal apparatus 16. In the case where the location is locked, the user who has reserved the location is permitted to unlock the location to use the location.

The service reservation management device 12 is configured to manage services that are available at each location, and manage a reservation of a service to be used at each location. For example, services that are available at a location are set in advance for each location, and the service reservation management device 12 stores information that indicates such settings. For example, in the case where a user reserves a service, the user who has reserved the service is permitted to use the reserved service. For example, in the case where a user reserves a service with designation of a time for which use of the service is allowed, the user is permitted to use the reserved service during the time. The time is defined by the date and the time slot, for example.

The service reservation management device 12 manages service identification information for identifying the reserved service, service reserving person identification information for identifying the user who has reserved the service (i.e. the reserving person of the service), and service reservation time information for identifying the time for which the service is to be used (i.e. the service reservation time) in connection with each service, for example. The service reservation management device 12 generates service reservation management information for managing such connection, and stores the service reservation management information. The service reserving person identification information includes the name of the user, the user ID, the user account, etc. The service reservation time information indicates the date and time, the time slot, etc. For example, a user is able to reserve a service by operating the terminal apparatus 16.

The location may be a location that may be used for a charge, or may be a location that may be used for free. In the case where the location is provided to the user for a charge, a billing process for the provided location may be performed by the location reservation management device 10, or may be performed by a different device such as a billing server. The service may be a service that may be used for a charge, or may be a service that may be used for free. In the case where the service is provided to the user for a charge, a billing process for the provided service may be performed by the service reservation management device 12, or may be performed by a different device such as a billing server. The location and the service may be provided by the same provider (e.g. a business operator etc.), or may be provided by different providers.

The reservation management device 14 is configured to output, in the case where the user who has reserved the location (i.e. the reserving person of the location) and the user who has reserved the service to be used at the location (i.e. the reserving person of the service) do not match each other, information (hereinafter referred to as “mismatch information”) indicating that such users do not match each other. Outputting the mismatch information includes transmitting the mismatch information to an external device (e.g. the terminal apparatus 16), displaying the mismatch information on a display device (e.g. a display device of the terminal apparatus 16), outputting the mismatch information as voice information (e.g. causing a speaker of the terminal apparatus 16 to generate the mismatch information as voice information), etc.

For example, the reservation management device 14 determines whether or not the location reserving person and the service reserving person match each other by acquiring a part or all of the location reservation management information from the location reservation management device 10, acquiring a part or all of the service reservation management information from the service reservation management device 12, and comparing the location reservation management information and the service reservation management information.

Examples of the terminal apparatus 16 include a PC, a tablet PC, a smartphone, a cellular phone, etc. The terminal apparatus 16 may be a device (e.g. a wearable device) to be worn by the user. The wearable device may be a glass-type device, a contact lens-type device to be worn on an eye, or a device (e.g. an ear-wearable device) to be worn on an ear.

The hardware configuration of the location reservation management device 10 will be described below with reference to FIG. 2. FIG. 2 illustrates an example of the hardware configuration of the location reservation management device 10.

The location reservation management device 10 includes a communication device 18, a user interface (UI) 20, a memory 22, and a processor 24, for example.

The communication device 18 is a communication interface that includes a communication chip, a communication circuit, etc., and has a function of transmitting information to a different device and a function of receiving information transmitted from a different device. The communication device 18 may have a wireless communication function, or may have a wired communication function. The communication device 18 may communicate with a different device by using near-field wireless communication, or may communicate with a different device via a communication path such as a local area network (LAN) or the Internet, for example.

The UI 20 is a user interface, and includes at least one of a display device and an operation device. The display device may be a liquid crystal display, an electroluminescence (EL) display, etc. The operation device may be a keyboard, an input key, an operation panel, etc. The UI 20 may be a UI that serves as both the display device and the operation device such as a touch screen. The location reservation management device 10 may not include the UI 20.

The memory 22 is a device that constitutes one or more storage areas that store various kinds of information. Examples of the memory 22 include a hard disk drive, various types of memories (e.g. a random access memory (RAM), a dynamic random access memory (DRAM), a read only memory (ROM), etc.), other storage devices (e.g. an optical disk etc.), and a combination thereof. One or more memories 22 are included in the location reservation management device 10. The memory 22 stores the location reservation management information.

The processor 24 is configured to control operation of various portions of the location reservation management device 10. The processor 24 may include a memory.

The processor 24 manages reservations of locations. For example, the processor 24 makes a reservation of a location, changes a reservation of a location, and cancels a reservation of a location. For example, when information that indicates a request for a reservation of a location, information that indicates a change of a reservation of a location, or information that indicates cancellation of a reservation of a location is transmitted from the terminal apparatus 16 to the location reservation management device 10, the processor 24 receives the information transmitted from the terminal apparatus 16, and makes a reservation of the location, changes the reservation of the location, or cancels the reservation of the location in accordance with the information. For example, the processor 24 adds information about a reservation of a location to the location reservation management information in accordance with information that indicates a request for the reservation, changes information about a reservation registered in the location reservation management information in accordance with information that indicates a change of the reservation, and cancels a reservation registered in the location reservation management information in accordance with information that indicates cancellation of the reservation. A request for a reservation of a location, an instruction for a change of a reservation of a location, and an instruction for cancellation of a reservation of a location may be given from the user via a screen on the display device, or may be given through a voice. A notification of the completion of a reservation, a notification of the completion of a change of a reservation, and a notification of the completion of cancellation of a reservation may be displayed on the display device, or may be generated from a speaker as a voice.

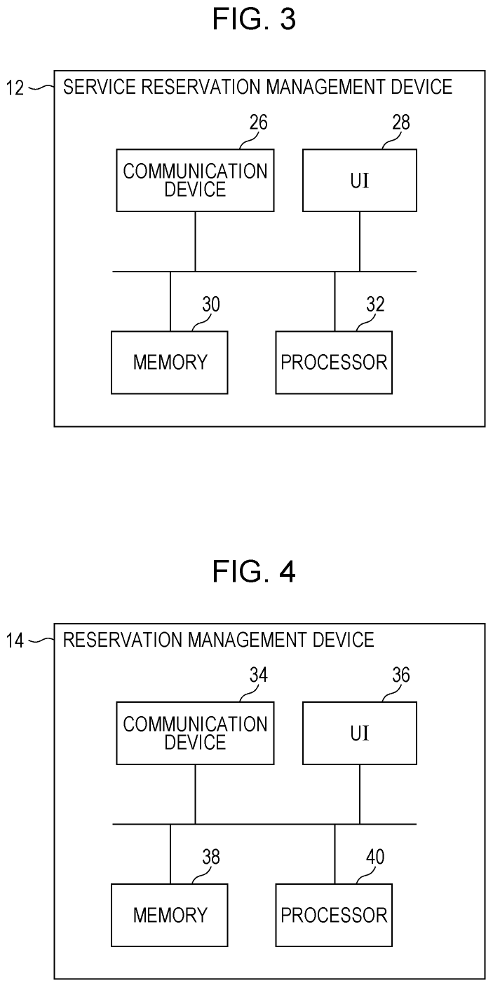

The hardware configuration of the service reservation management device 12 will be described below with reference to FIG. 3. FIG. 3 illustrates an example of the hardware configuration of the service reservation management device 12.

The service reservation management device 12 includes a communication device 26, a UI 28, a memory 30, and a processor 32, for example.

The communication device 26 is a communication interface that includes a communication chip, a communication circuit, etc., and has a function of transmitting information to a different device and a function of receiving information transmitted from a different device. The communication device 26 may have a wireless communication function, or may have a wired communication function. The communication device 26 may communicate with a different device by using near-field wireless communication, or may communicate with a different device via a communication path such as a local area network (LAN) or the Internet, for example.

The UI 28 is a user interface, and includes at least one of a display device and an operation device. The display device may be a liquid crystal display, an electroluminescence (EL) display, etc. The operation device may be a keyboard, an input key, an operation panel, etc. The UI 28 may be a UI that serves as both the display device and the operation device such as a touch screen. The service reservation management device 12 may not include the UI 28.

The memory 30 is a device that constitutes one or more storage areas that store various kinds of information. Examples of the memory 30 include a hard disk drive, various types of memories (e.g. a random access memory (RAM), a dynamic random access memory (DRAM), a read only memory (ROM), etc.), other storage devices (e.g. an optical disk etc.), and a combination thereof. One or more memories 30 are included in the service reservation management device 12. The memory 30 stores the service reservation management information.

The processor 32 is configured to control operation of various portions of the service reservation management device 12. The processor 32 may include a memory.

The processor 32 manages reservations of services. For example, the processor 32 makes a reservation of a service, changes a reservation of a service, and cancels a reservation of a service. For example, when information that indicates a request for a reservation of a service, information that indicates a change of a reservation of a service, or information that indicates cancellation of a reservation of a service is transmitted from the terminal apparatus 16 to the service reservation management device 12, the processor 32 receives the information transmitted from the terminal apparatus 16, and makes a reservation of the service, changes the reservation of the service, or cancels the reservation of the service in accordance with the information. For example, the processor 32 adds information about a reservation of a service to the service reservation management information in accordance with information that indicates a request for the reservation, changes information about a reservation registered in the service reservation management information in accordance with information that indicates a change of the reservation, and cancels a reservation registered in the service reservation management information in accordance with information that indicates cancellation of the reservation. A request for a reservation of a service, an instruction for a change of a reservation of a service, and an instruction for cancellation of a reservation of a service may be given from the user via a screen on the display device, or may be given through a voice. A notification of the completion of a reservation, a notification of the completion of a change of a reservation, and a notification of the completion of cancellation of a reservation may be displayed on the display device, or may be generated from a speaker as a voice.

The hardware configuration of the reservation management device 14 will be described below with reference to FIG. 4. FIG. 4 illustrates an example of the hardware configuration of the reservation management device 14.

The reservation management device 14 includes a communication device 34, a user interface (UI) 36, a memory 38, and a processor 40, for example.

The communication device 34 is a communication interface that includes a communication chip, a communication circuit, etc., and has a function of transmitting information to a different device and a function of receiving information transmitted from a different device. The communication device 34 may have a wireless communication function, or may have a wired communication function. The communication device 34 may communicate with a different device by using near-field wireless communication, or may communicate with a different device via a communication path such as a local area network (LAN) or the Internet, for example.

The UI 36 is a user interface, and includes at least one of a display device and an operation device. The display device may be a liquid crystal display, an electroluminescence (EL) display, etc. The operation device may be a keyboard, an input key, an operation panel, etc. The UI 36 may be a UI that serves as both the display device and the operation device such as a touch screen. The reservation management device 14 may not include the UI 36.

The memory 38 is a device that constitutes one or more storage areas that store various kinds of information. Examples of the memory 38 include a hard disk drive, various types of memories (e.g. a random access memory (RAM), a dynamic random access memory (DRAM), a read only memory (ROM), etc.), other storage devices (e.g. an optical disk etc.), and a combination thereof. One or more memories 38 are included in the reservation management device 14.

The memory 38 may store the location reservation management information which is managed by the location reservation management device 10 and the service reservation management information which is managed by the service reservation management device 12.

The processor 40 is configured to control operation of various portions of the reservation management device 14. The processor 40 may include a memory.

The processor 40 is configured to output, in the case where the user who has reserved the location (i.e. the reserving person of the location) and the user who has reserved the service to be used at the location (i.e. the reserving person of the service) do not match each other, mismatch information indicating that such users do not match each other.

The mismatch information may be information that prompts the reserving person to correct the reservation of the location or the reservation of the service, for example.

The processor 40 may transmit, to the terminal apparatus 16 of the reserving person of the location, mismatch information including information indicating that the service is not reserved by the reserving person of the location. The mismatch information may be displayed on the display device of the terminal apparatus 16, or may be generated from the speaker of the terminal apparatus 16 as a voice.

The processor 40 may transmit, to the terminal apparatus 16 of the reserving person of the service, mismatch information including information indicating that the location is not reserved by the reserving person of the service. The mismatch information may be displayed on the display device of the terminal apparatus 16, or may be generated from the speaker of the terminal apparatus 16 as a voice.

For example, the processor 40 determines whether or not the location reserving person and the service reserving person match each other by acquiring a part or all of the location reservation management information from the location reservation management device 10, acquiring a part or all of the service reservation management information from the service reservation management device 12, and comparing the location reservation management information and the service reservation management information.

For example, the processor 40 may acquire location reservation management information from the location reservation management device 10 and acquire service reservation management information from the service reservation management device 12 at time intervals determined in advance. In another example, in the case where the location reservation management information is updated by the location reservation management device 10, the updated location reservation management information may be transmitted from the location reservation management device 10 to the reservation management device 14, and the processor 40 may acquire the updated location reservation management information. Similarly, in the case where the service reservation management information is updated by the service reservation management device 12, the updated service reservation management information may be transmitted from the service reservation management device 12 to the reservation management device 14, and the processor 40 may acquire the updated service reservation management information. The processor 40 may store the acquired location reservation management information and the acquired service reservation management information in the memory 38.

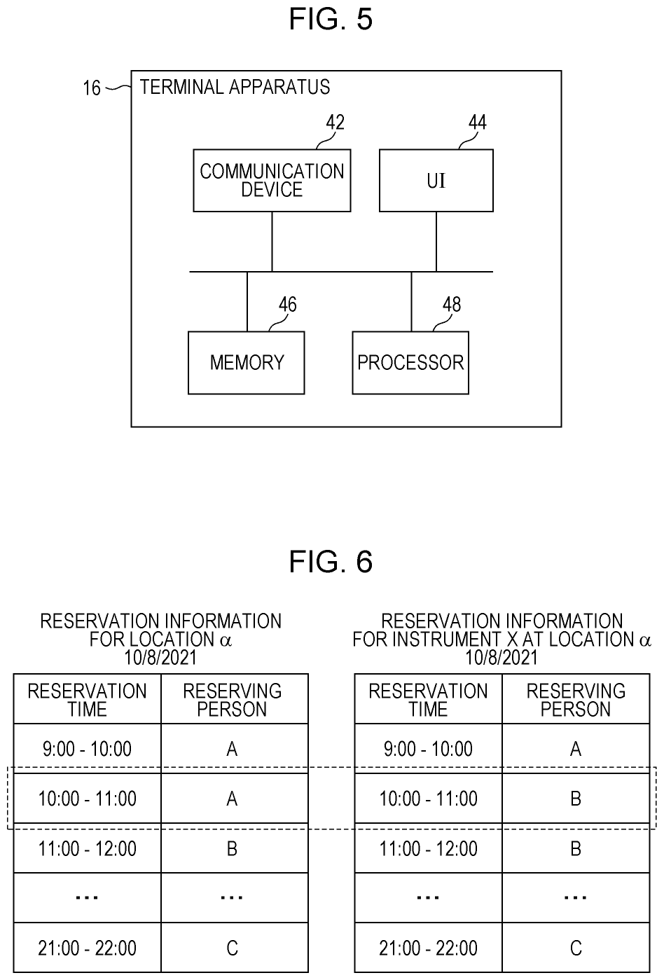

The hardware configuration of the terminal apparatus 16 will be described below with reference to FIG. 5. FIG. 5 illustrates an example of the hardware configuration of the terminal apparatus 16.

The terminal apparatus 16 includes a communication device 42, a user interface (UI) 44, a memory 46, and a processor 48, for example.

The communication device 42 is a communication interface that includes a communication chip, a communication circuit, etc., and has a function of transmitting information to a different device and a function of receiving information transmitted from a different device. The communication device 42 may have a wireless communication function, or may have a wired communication function. The communication device 42 may communicate with a different device by using near-field wireless communication, or may communicate with a different device via a communication path such as a local area network (LAN) or the Internet, for example.

The UI 44 is a user interface, and includes at least one of a display device and an operation device. The display device may be a liquid crystal display, an electroluminescence (EL) display, etc. The operation device may be a keyboard, an input key, an operation panel, etc. The UI 44 may be a UI that serves as both the display device and the operation device such as a touch screen. The UI 44 may include a speaker.

The memory 46 is a device that constitutes one or more storage areas that store various kinds of information. Examples of the memory 46 include a hard disk drive, various types of memories (e.g. a random access memory (RAM), a dynamic random access memory (DRAM), a read only memory (ROM), etc.), other storage devices (e.g. an optical disk etc.), and a combination thereof. One or more memories 46 are included in the terminal apparatus 16.

The processor 48 is configured to control operation of various portions of the terminal apparatus 16. The processor 48 may include a memory.

The information processing system according to the present exemplary embodiment will be described in further detail below.

An example of the location reservation management information and the service reservation management information will be described with reference to FIG. 6. FIG. 6 illustrates an example of a location reservation management table and a service reservation management table. The location reservation management table is an example of the location reservation management information. The service reservation management table is an example of the service reservation management information.

The location reservation management table is managed by the location reservation management device 10, and data in the location reservation management table are stored in the memory 22 of the location reservation management device 10. The data in the location reservation management table are transmitted from the location reservation management device 10 to the reservation management device 14 at time intervals determined in advance, at a desired time, or when the location reservation management table is updated, for example.

The service reservation management table is managed by the service reservation management device 12, and data in the service reservation management table are stored in the memory 30 of the service reservation management device 12. The data in the service reservation management table are transmitted from the service reservation management device 12 to the reservation management device 14 at time intervals determined in advance, at a desired time, or when the service reservation management table is updated, for example.

FIG. 6 illustrates a location reservation management table for managing reservation information for a location α and a service reservation management table for managing reservation information for an instrument X to be used at the location α. The instrument X is an example of the service. While a process performed in the case where the instrument X is lent to the user as an example of the service is described, a similar process is performed also in the case where a service other than the instrument X is lent to the user.

In the location reservation management table for the location α, location reservation time information that indicates the time of reservation of the location α (i.e. the time for which the location α is used) and location reserving person identification information for identifying the user who has reserved the location α (i.e. the reserving person of the location α) are connected with each other. For example, information requesting a reservation of the location α (e.g. information including location identification information for identifying the location α, location reserving person identification information for identifying the user who reserves the location α, and location reservation time information that indicates the location reservation time which is the time for which the location is to be used) is transmitted from the terminal apparatus 16 of the user who reserves the location α to the location reservation management device 10, and such information is registered in the location reservation management table. The reserving person of the location α is the user who is scheduled to use the location α. That is, it is assumed that the user who is registered as the reserving person of the location α uses the location α.

In the service reservation management table for the instrument X to be used at the location α, service reservation time information that indicates the time of reservation of the instrument X (i.e. the time for which the instrument X is used) and service reserving person identification information for identifying the user who has reserved the instrument X (i.e. the reserving person of the instrument X) are connected with each other. For example, information requesting a reservation of the instrument X (e.g. information including service identification information for identifying the instrument X, service reserving person identification information for identifying the user who reserves the instrument X, and service reservation time information that indicates the service reservation time which is the time for which the instrument X is to be used) is transmitted from the terminal apparatus 16 of the user who reserves the instrument X to the service reservation management device 12, and such information is registered in the service reservation management table. The reserving person of the instrument X is the user who is scheduled to use the instrument X. That is, it is assumed that the user who is registered as the reserving person of the instrument X uses the instrument X.

The processor 40 of the reservation management device 14 compares the location reservation management table for the location α and the service reservation management table for the instrument X to be used at the location α and, in the case where the reserving person of the location α and the reserving person of the instrument X do not match each other, outputs mismatch information indicating that such users do not match each other.

The mismatch information may be information that prompts the reserving person to correct the reservation of the location α or the reservation of the instrument X, for example.

The processor 40 of the reservation management device 14 may transmit, to the terminal apparatus 16 of the reserving person of the location α, mismatch information including information indicating that the instrument X is not reserved by the reserving person of the location α.

The processor 40 of the reservation management device 14 may transmit, to the terminal apparatus 16 of the reserving person of the instrument X, mismatch information including information indicating that the location α is not reserved by the reserving person of the instrument X.

For example, the processor 40 of the reservation management device 14 outputs mismatch information in the case where the reserving person of the location α and the reserving person of the instrument X do not match each other in a time slot in which the reservation of the location α and the reservation of the instrument X overlap each other.

A specific example is described. In a reservation time “9:00 to 10:00”, each of the location α and the instrument X is reserved by a user A. That is, the location α and the instrument X are reserved by the same user A. In this case, the processor 40 of the reservation management device 14 does not output mismatch information. That is, the processor 40 of the reservation management device 14 does not transmit mismatch information to the terminal apparatus 16 of the user A.

In a reservation time “10:00 to 11:00”, on the other hand, the location α is reserved by the user A, and the instrument X is reserved by a user B. That is, the location α and the instrument X are reserved by different users. In this case, the processor 40 of the reservation management device 14 outputs mismatch information.

For example, the processor 40 of the reservation management device 14 transmits, to the terminal apparatus 16A of the user A, mismatch information including information indicating that the instrument X is not reserved by the user A who is the reserving person of the location α. The processor 48 of the terminal apparatus 16A displays the mismatch information on the display device of the UI 44 of the terminal apparatus 16A. The processor 48 of the terminal apparatus 16A may generate the mismatch information as a voice from the speaker of the UI 44 of the terminal apparatus 16A. The processor 48 of the terminal apparatus 16A may display the mismatch information on the display device and generate the mismatch information as a voice from the speaker. The processor 48 of the terminal apparatus 16A may display the mismatch information on the display device or generate the mismatch information as a voice from the speaker.

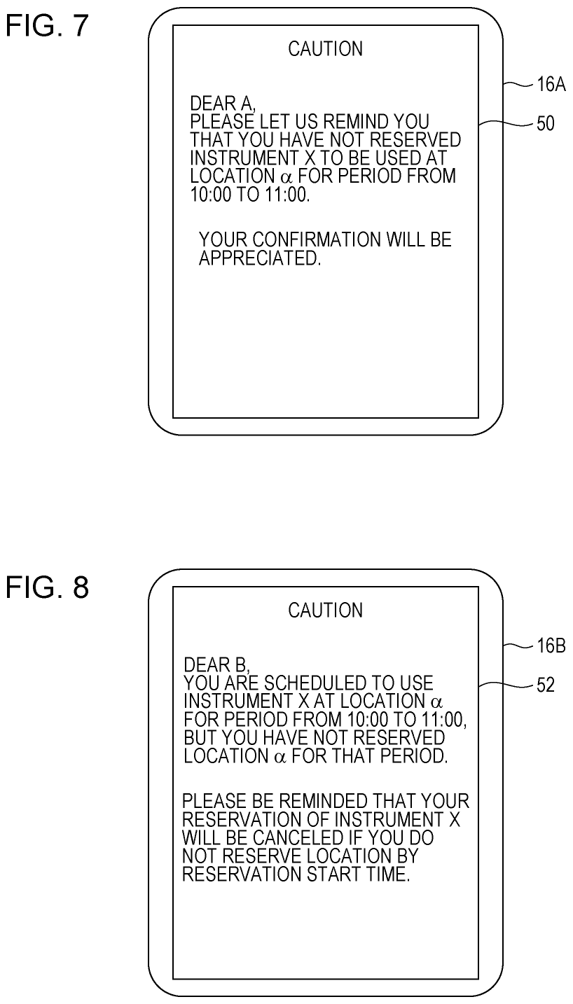

The mismatch information to be displayed on the terminal apparatus 16A will be described with reference to FIG. 7. FIG. 7 illustrates a screen 50 of the display device of the terminal apparatus 16A. The screen 50 displays the mismatch information which is transmitted from the reservation management device 14 to the terminal apparatus 16A. The mismatch information may be information that prompts the user A to correct the reservation of the instrument X, for example. Specifically, the mismatch information is information that cautions the user A that the instrument X is not reserved by the user A for a period from 10:00 to 11:00. The processor 48 of the terminal apparatus 16A may display the mismatch information on the screen 50 and generate the mismatch information from the speaker. As a matter of course, the processor 48 of the terminal apparatus 16A may generate the mismatch information as a voice from the speaker without displaying the mismatch information on the screen 50.

In addition, the processor 40 of the reservation management device 14 transmits, to a terminal apparatus 16B of the user B, mismatch information including information indicating that the location α is not reserved by the user B who is the reserving person of the instrument X. The processor 48 of the terminal apparatus 16B displays the mismatch information on the display device of the UI 44 of the terminal apparatus 16B. The processor 48 of the terminal apparatus 16B may generate the mismatch information as a voice from the speaker of the UI 44 of the terminal apparatus 16B. The processor 48 of the terminal apparatus 16B may display the mismatch information on the display device and generate the mismatch information as a voice from the speaker. The processor 48 of the terminal apparatus 16B may display the mismatch information on the display device or generate the mismatch information as a voice from the speaker.

The mismatch information to be displayed on the terminal apparatus 16B will be described with reference to FIG. 8. FIG. 8 illustrates a screen 52 of the display device of the terminal apparatus 16B. The screen 52 displays the mismatch information which is transmitted from the reservation management device 14 to the terminal apparatus 16B. The mismatch information may be information that prompts the user B to correct the reservation of the location α, for example. Specifically, the mismatch information is information that cautions the user B that the location α is not reserved by the user B for a period from 10:00 to 11:00. The processor 48 of the terminal apparatus 16B may display the mismatch information on the screen 52 and generate the mismatch information from the speaker. As a matter of course, the processor 48 of the terminal apparatus 16B may generate the mismatch information as a voice from the speaker without displaying the mismatch information on the screen 52.

The processor 40 of the reservation management device 14 may output mismatch information when the location α is reserved or when the instrument X is reserved.

For example, in the case where a user (e.g. the user B) other than the user A has already made a reservation to use the instrument X for a period from 10:00 to 11:00 when the user A makes a reservation to use the location α for a period from 10:00 to 11:00, the processor 40 of the reservation management device 14 transmits mismatch information for the user A to the terminal apparatus 16A of the user A. The processor 40 of the reservation management device 14 may additionally transmit mismatch information for the user B to the terminal apparatus 16B of the user B.

In the case where a user (e.g. the user A) other than the user B has already made a reservation to use the location α for a period from 10:00 to 11:00 when the user B makes a reservation to use the instrument X for a period from 10:00 to 11:00, the processor 40 of the reservation management device 14 transmits mismatch information for the user B to the terminal apparatus 16B of the user B. The processor 40 of the reservation management device 14 may additionally transmit mismatch information for the user A to the terminal apparatus 16A of the user A.

In another example, the processor 40 of the reservation management device 14 may output mismatch information in the case where a time determined in advance elapses since the time when the location α is reserved or the time when the instrument X is reserved. The time determined in advance may be changed by a manager etc.

In the case where the mismatch between the reserving person of the location α and the reserving person of the instrument X is not resolved by the start time of the reservation of the location α or by the start time of the reservation of the instrument X, in addition, the processor 40 of the reservation management device 14 may withdraw (i.e. cancel) the reservation of the location α or the reservation of the instrument X. In this case, the processor 40 of the reservation management device 14 transmits information that instructs such cancellation to the location reservation management device 10 or the service reservation management device 12. The processor 24 of the location reservation management device 10 cancels the reservation of the location α in accordance with the instruction upon receiving the information that instructs such cancellation. The processor 32 of the service reservation management device 12 cancels the reservation of the instrument X in accordance with the instruction upon receiving the information that instructs such cancellation. The processor 40 of the reservation management device 14 may transmit information that instructs cancellation to either the location reservation management device 10 or the service reservation management device 12, or may transmit such information to both the location reservation management device 10 and the service reservation management device 12.

In the example illustrated in FIG. 6, for example, the processor 40 of the reservation management device 14 transmits, to the service reservation management device 12, information that instructs cancellation of the reservation of the instrument X for the period from 10:00 to 11:00 in the case where the mismatch between the reserving person of the location α and the reserving person of the instrument X is not resolved by the start time of the reservation of the location α and the instrument X (e.g. by 10:00). The processor 32 of the service reservation management device 12 cancels the reservation of the instrument X for the period from 10:00 to 11:00 in accordance with such an instruction. That is, the reservation for the user B to use the instrument X for the period from 10:00 to 11:00 will be canceled unless the user B makes a reservation to use the location α for the period from 10:00 to 11:00 by the start time of the reservation of the instrument X (e.g. by 10:00). In this case, as illustrated in FIG. 8, a message indicating that the reservation of the instrument X will be canceled is displayed on the screen 52. The message may be generated from a speaker as a voice.

In another example, the processor 40 of the reservation management device 14 may transmit, to the location reservation management device 10, information that instructs cancellation of the reservation of the location α for the period from 10:00 to 11:00 in the case where the mismatch between the reserving person of the location α and the reserving person of the instrument X is not resolved by the start time of the reservation of the location α and the instrument X (e.g. by 10:00). The processor 24 of the location reservation management device 10 cancels the reservation of the location α for the period from 10:00 to 11:00 in accordance with such an instruction. That is, the reservation for the user A to use the location α for the period from 10:00 to 11:00 will be canceled unless the user A makes a reservation to use the instrument X for the period from 10:00 to 11:00 by the start time of the reservation of the location α (e.g. by 10:00). In this case, a message indicating that the reservation of the location α will be canceled is displayed on the screen 50. The message may be generated from a speaker as a voice.

While the reservation time of the location α and the reservation time of the instrument X completely match each other in the example illustrated in FIG. 6, the reservation time of the location α and the reservation time of the instrument X may partially match each other.

In this case, the processor 40 of the reservation management device 14 outputs the mismatch information discussed above in the case where the reserving person of the location α and the reserving person of the instrument X do not match each other at the partially matching reservation time. For example, the processor 40 of the reservation management device 14 outputs the mismatch information discussed above in the case where the user A has a reservation to use the location α for a period from 9:00 to 10:00 and the user B has a reservation to use the instrument X for a period from 9:30 to 10:30.

On the other hand, the processor 40 of the reservation management device 14 does not output the mismatch information discussed above in the case where the reserving person of the location α and the reserving person of the instrument X match each other at the partially matching reservation time. For example, the processor 40 of the reservation management device 14 does not output the mismatch information discussed above in the case where the user A has a reservation to use the location α for a period from 9:00 to 10:00 and the user A has a reservation to use the instrument X for a period from 9:30 to 10:30.

While it is assumed that one user uses a location and an instrument in the example illustrated in FIG. 6 and discussed above, a location and a service may be used by one or more users. This respect will be described in detail with reference to FIG. 9. FIG. 9 illustrates an example of a location reservation management table for managing reservation information for the location α and a service reservation management table for managing reservation information for the instrument X to be used at the location α.

In a reservation time “10:00 to 11:00”, for example, the location α is reserved by the users A and B. That is, the location α is reserved to be used by two users (users A and B). On the other hand, the instrument X to be used at the location α for the time slot is reserved by the user B. In this manner, the reserving person of the location α and the reserving person of the instrument X occasionally do not match each other. In the example illustrated in FIG. 9, the location α is reserved by two users, and the instrument X is reserved by one user. If the location α is reserved by one or more users and the instrument X is reserved by one or more users in another example, the reserving person of the location α and the reserving person of the instrument X occasionally do not match each other.

For example, the processor 40 of the reservation management device 14 outputs mismatch information in the case where a plurality of users have a reservation to use the location α and the plurality of users and the reserving person of the instrument X do not match each other. In the example illustrated in FIG. 9, the processor 40 of the reservation management device 14 outputs mismatch information, since the reserving person of the location α and the reserving person of the instrument X do not match each other in a time slot from 10:00 to 11:00. In this case, the processor 40 of the reservation management device 14 transmits, to each of the terminal apparatuses 16 of the users A and B, mismatch information indicating that the reserving person of the location α and the reserving person of the instrument X do not match each other. The mismatch information may include information that prompts the user A to reserve the instrument X, for example.

In another example, the processor 40 of the reservation management device 14 may transmit mismatch information to the terminal apparatus 16 of the user A who has reserved the location α but who has not reserved the instrument X, and may not transmit mismatch information to the terminal apparatus 16 of the user B. That is, the processor 40 of the reservation management device 14 may transmit mismatch information to the terminal apparatus 16 of a user registered as the reserving person of only one of the location α and the instrument X, and may not transmit mismatch information to the terminal apparatus 16 of a user registered as the reserving person of both of the location α and the instrument X.

In another example, the processor 40 of the reservation management device 14 may output mismatch information in the case where a plurality of users have a reservation to use the location α and the plurality of users (i.e. the reserving person of the location α) and the reserving person of the instrument X do not match each other at all, and may not output mismatch information in the case where the plurality of users (i.e. the reserving person of the location α) and the reserving person of the instrument X partially match each other.

The case where the reserving person of the location α and the reserving person of the instrument X do not match each other at all corresponds to a case where one or more users who have reserved the location α and one or more users who have reserved the instrument X are completely different users with no partial overlap therebetween.

In the example illustrated in FIG. 9, for the time slot from 10:00 to 11:00, the reserving person of the location α includes the users A and B, and the reserving person of the instrument X includes the user B. Since the user B is registered as the reserving person of both the location α and the instrument X in this manner, the reserving person of the location α and the reserving person of the instrument X partially match each other. In this case, the processor 40 of the reservation management device 14 does not output mismatch information.

The processor 40 of the reservation management device 14 may output mismatch information, or may not output mismatch information, in accordance with the characteristics of the reserved service in the case where the reserving person of the location and the reserving person of the service partially match each other. For example, the processor 40 of the reservation management device 14 does not output mismatch information in the case where it is assumed that the service is shared by a plurality of users and the reserving person of the location and the reserving person of the service partially match each other. On the other hand, the processor 40 of the reservation management device 14 outputs mismatch information in the case where it is assumed that the service is not shared by a plurality of users (i.e. the service is separately provided to the users so that each of the users uses the service provided to himself/herself), even in the case where the reserving person of the location and the reserving person of the service partially match each other.

The example illustrated in FIG. 9 will be described. The processor 40 of the reservation management device 14 does not output mismatch information in the case where it is assumed that the instrument X is to be shared by a plurality of users and the reserving person of the location α and the reserving person of the instrument X partially match each other. For example, the processor 40 of the reservation management device 14 does not output mismatch information in the case where the location α is reserved by a plurality of users and the instrument X is reserved by some of the plurality of users.

On the other hand, the processor 40 of the reservation management device 14 outputs mismatch information in the case where it is assumed that the instrument X is not to be shared by a plurality of users, even in the case where the reserving person of the location α and the reserving person of the instrument X partially match each other. For example, the processor 40 of the reservation management device 14 outputs mismatch information in the case where the location α is reserved by a plurality of users and the instrument X is reserved by some of the plurality of users.

The following example is conceivable as an example in which a service is shared by a plurality of users. A cooking utensil is occasionally lent as the instrument X to a plurality of users in the case where the plurality of users gather at a location α to cook, for example. In this case, it is assumed that the cooking utensil is not separately provided to the users but is shared by the plurality of users. Thus, the cooking utensil is occasionally reserved by some of the plurality of users who use the location α. In this case, the reserving person of the location α and the reserving person of the instrument X occasionally partially match each other. The example illustrated in FIG. 9 will be described. It is conceivable that the cooking utensil is reserved by the user B in the case where the location α is to be used by the users A and B and the instrument X which is a cooking utensil is used at the location α. The processor 40 of the reservation management device 14 does not output mismatch information, since it is not necessary that the cooking utensil should be reserved by the plurality of users.

The cooking utensil is an example of an instrument to be shared by a plurality of users. An instrument or a service other than the cooking utensil may be shared by a plurality of users. For example, the memory 38 of the reservation management device 14 stores information indicating whether or not each service is assumed to be shared by a plurality of users, and the processor 40 of the reservation management device 14 references the information to determine whether or not a reserved service is assumed to be shared by a plurality of users.

The following example is conceivable as an example in which a service is not shared by a plurality of users but is provided to each of the users. The processor 40 of the reservation management device 14 outputs mismatch information in the case where a user is allowed to use a service when one license is given to each user, even in the case where the reserving person of a location and the reserving person of the service partially match each other, for example. Examples of such a service include software. That is, each user is allowed to use software provided to the user himself/herself using a license for the software given to the user himself/herself when such a license is given to each user. In such an example, the processor 40 of the reservation management device 14 outputs mismatch information even in the case where the reserving person of the location and the reserving person of the software partially match each other.

Tableware (e.g. cups, dishes, etc.), for example, is conceivable as a different example of the instrument to be provided to each user. It is conceivable that tableware is provided to each user that uses a location which is an eating place in the case where the location provides an all-you-can-eat menu, an all-you-can-drink menu, etc., for example. Such tableware is not assumed to be shared by a plurality of users, but is assumed to be provided to each user. In such a case, the processor 40 of the reservation management device 14 outputs mismatch information even in the case where the reserving person of the location and the reserving person of the tableware partially match each other.

The processor 40 of the reservation management device 14 may control a reservation of a location or a service such that the reserving person of the location and the reserving person of the service completely match each other in the case where the reserving person of the location and the reserving person of the service do not partially match each other.

This process will be described with reference to FIG. 9. For the time slot from 10:00 to 11:00, the reserving person of the location α includes the users A and B, and the reserving person of the instrument X includes the user B only. In this case, the processor 40 of the reservation management device 14 transmits, to the service reservation management device 12, information that indicates an instruction to forcibly add the user A to the reserving person of the instrument X. The processor 32 of the service reservation management device 12 adds the user A to the reserving person of the instrument X in accordance with the instruction, and transmits, to the terminal apparatus 16 of the user A, information indicating that the user A has been added to the reserving person of the instrument X. Under a system in which one is billed when he/she uses a service, for example, the user A is billed when the user A is added to the reserving person of the instrument X. The processor 32 of the service reservation management device 12 may transmit, to the terminal apparatus 16 of the user A, information indicating that the user A is to be added to the reserving person of the instrument X before the user A is added to the reserving person of the instrument X. In this case, the processor 32 of the service reservation management device 12 adds the user A to the reserving person of the instrument X in the case where addition of the user A to the reserving person of the instrument X is permitted by the user A. The processor 32 of the service reservation management device 12 may cancel the reservation of the instrument X by the user B in the case where addition of the user A to the reserving person of the instrument X is not permitted by the user A.

In another example, in the case where the reserving person of the location α includes the users A and B and the reserving person of the instrument X includes the user B only, the processor 40 of the reservation management device 14 may transmit, to the location reservation management device 10, information indicating an instruction to exclude the user A from the reserving person of the location α. The processor 24 of the location reservation management device 10 excludes the user A from the reserving person of the location α in accordance with the instruction, and transmits, to the terminal apparatus 16 of the user A, information indicating that the user A has been excluded from the reserving person of the location α. The processor 24 of the location reservation management device 10 may transmit, to the terminal apparatus 16 of the user A, information indicating that the user A is to be excluded from the reserving person of the location α before the user A is excluded from the reserving person of the location α. In this case, the processor 24 of the location reservation management device 10 excludes the user A from the reserving person of the location α in the case where exclusion of the user A from the reserving person of the location α is permitted by the user A. The processor 24 of the location reservation management device 10 may cancel the reservation of the location α by the users A and B in the case where exclusion of the user A from the reserving person of the location α is not permitted by the user A.

In the case where the reserving person of the location α includes the user A only and the reserving person of the instrument X includes the users A and B, the processor 40 of the reservation management device 14 may transmit, to the location reservation management device 10, information indicating an instruction to forcibly add the user B to the reserving person of the location α. The processor 24 of the location reservation management device 10 adds the user B to the reserving person of the location α in accordance with the instruction, and transmits, to the terminal apparatus 16 of the user B, information indicating that the user B has been added to the reserving person of the location α. Under a system in which one is billed when he/she uses a location, for example, the user B is billed when the user B is added to the reserving person of the location α. The processor 24 of the location reservation management device 10 may transmit, to the terminal apparatus 16 of the user B, information indicating that the user B is to be added to the reserving person of the location α before the user B is added to the reserving person of the location α. In this case, the processor 24 of the location reservation management device 10 adds the user B to the reserving person of the location α in the case where addition of the user B to the reserving person of the location α is permitted by the user B. The processor 24 of the location reservation management device 10 may cancel the reservation of the location α by the user A in the case where addition of the user B to the reserving person of the location α is not permitted by the user B.

In another example, in the case where the reserving person of the location α includes the user A only and the reserving person of the instrument X includes the users A and B, the processor 40 of the reservation management device 14 may transmit, to the service reservation management device 12, information indicating an instruction to exclude the user B from the reserving person of the instrument X. The processor 32 of the service reservation management device 12 excludes the user B from the reserving person of the instrument X in accordance with the instruction, and transmits, to the terminal apparatus 16 of the user B, information indicating that the user B has been excluded from the reserving person of the instrument X. The processor 32 of the service reservation management device 12 may transmit, to the terminal apparatus 16 of the user B, information indicating that the user B is to be excluded from the reserving person of the instrument X before the user B is excluded from the reserving person of the instrument X. In this case, the processor 32 of the service reservation management device 12 excludes the user B from the reserving person of the instrument X in the case where exclusion of the user B from the reserving person of the instrument X is permitted by the user B. The processor 32 of the service reservation management device 12 may cancel the reservation of the instrument X by the users A and B in the case where exclusion of the user B from the reserving person of the instrument X is not permitted by the user B.

A plurality of locations may be reserved by users who belong to the same group. In this case, the processor 40 of the reservation management device 14 may output mismatch information in the case where the reserving person of a service to be used at the plurality of locations and the reserving person of the plurality of locations do not match each other. For example, the processor 40 of the reservation management device 14 outputs mismatch information in the case where a first reserving person of a first location and a second reserving person of a second location belong to the same group and the reserving person of a service to be used at the first location and the second location and a combination of the first reserving person and the second reserving person do not match each other.

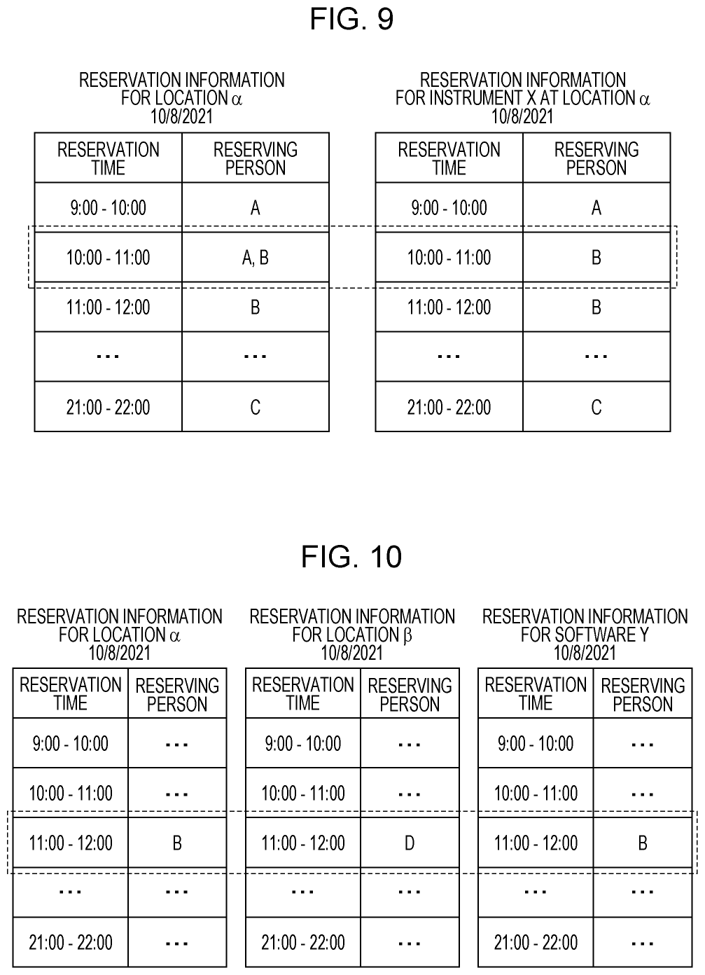

This process will be described with reference to FIG. 10. FIG. 10 illustrates an example of location reservation management tables for managing reservation information for the location α and a location β and a service reservation management table for managing reservation information for software Y to be used at the locations α and β. While a process performed in the case where the software Y is provided to the users is described by way of example, a similar process is performed also in the case where a service other than the software Y is provided to the users.

The location α corresponds to the first location, and the location β corresponds to the second location. The reserving person of the location α is the user B, and the reserving person of the location β is a user D. The users B and D belong to the same group, which is managed by the location reservation management device 10. For example, group identification information for identifying a group and user identification information for identifying users who belong to the group are connected to each other for each group, and such information is stored in the memory 22 of the location reservation management device 10 as group management information. Such information may be stored in advance in the memory 22 of the location reservation management device 10, or may be input by a user who is the reserving person when he/she reserves a location and stored in the memory 22. The processor 40 of the reservation management device 14 acquires the group management information from the location reservation management device 10, and identifies users who belong to each group.

The software Y is software (e.g. software for online conferencing) for communication between the location α and the location β, for example.

In the example illustrated in FIG. 10, the user B is scheduled to use the location α, the user D is scheduled to use the location β, and the users B and D are scheduled to have an online conference between the location α and the location β using the software Y. For example, the software Y for online conferencing is installed in the respective terminal apparatuses 16 of the users B and D so that the software Y is used on the respective terminal apparatuses 16 of the users B and D. In this manner, the software Y is used at different locations by the users B and D.

The software Y is reserved by the user B only, and not reserved by the user D. In this case, the processor 40 of the reservation management device 14 transmits mismatch information to each of the terminal apparatuses 16 of the users B and D, or to the terminal apparatus 16 of the user D. The mismatch information includes information indicating that the software Y has not been reserved by the user D who has reserved the location β. The mismatch information may additionally include information that prompts the user D to reserve the software Y.

The processor 40 of the reservation management device 14 may transmit, to the service reservation management device 12, information indicating an instruction to cancel the reservation of the software Y by the user B in the case where the software Y is not reserved by the user D even when a time determined in advance elapses since the time when the mismatch information is transmitted to the terminal apparatus 16 of the user D. In this case, the processor 32 of the service reservation management device 12 cancels the reservation of the software Y by the user B in accordance with the instruction. In another example, the processor 40 of the reservation management device 14 may transmit, to the location reservation management device 10, information indicating an instruction to cancel the reservation of the location β by the user D. In this case, the processor 24 of the location reservation management device 10 cancels the reservation of the location α by the user D in accordance with the instruction.

In the embodiment above, the processor refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
output, in a case where a person who has a reservation of a location and a person who has a reservation of a service to be used at the location do not match each other, information indicating that such reserving persons do not match each other.

2. The information processing apparatus according to claim 1,
wherein the information is information that prompts at least one of the reserving persons to correct the reservation of the location or the reservation of the service.

3. The information processing apparatus according to claim 1,
wherein the processor is configured to
output the information in a case where the reserving person of the location and the reserving person of the service do not match each other in a time slot in which the reservation of the location and the reservation of the service to be used at the location overlap each other.

4. The information processing apparatus according to claim 2,
wherein the processor is configured to
output the information in a case where the reserving person of the location and the reserving person of the service do not match each other in a time slot in which the reservation of the location and the reservation of the service to be used at the location overlap each other.

5. The information processing apparatus according to claim 3,
wherein the processor is configured to
cancel the reservation of the service in a case where mismatch between the reserving person of the location and the reserving person of the service is not resolved by a start time of the reservation of the location or a start time of the reservation of the service.

6. The information processing apparatus according to claim 4,
wherein the processor is configured to
cancel the reservation of the service in a case where mismatch between the reserving person of the location and the reserving person of the service is not resolved by a start time of the reservation of the location or a start time of the reservation of the service.

7. The information processing apparatus according to claim 1,
wherein the processor is configured to
output the information to a terminal apparatus of at least one of the reserving persons when the location is reserved or when the service is reserved.

8. The information processing apparatus according to claim 1,
wherein the processor is configured to
output the information to a terminal apparatus of at least one of the reserving persons in a case where a time determined in advance has elapsed since a time when the location is reserved or a time when the service is reserved.

9. The information processing apparatus according to claim 1,
wherein the processor is configured to
transmit, to a terminal apparatus of the reserving person of the location, information indicating that the service is not reserved by the reserving person of the location.

10. The information processing apparatus according to claim 1,
wherein the processor is configured to
transmit, to a terminal apparatus of the reserving person of the service, information indicating that the location is not reserved by the reserving person of the service.

11. The information processing apparatus according to claim 1,
wherein the processor is configured to
output the information in a case where a plurality of users have a reservation to use the location and the plurality of users and the reserving person of the service do not match each other.

12. The information processing apparatus according to claim 11,
wherein the processor is configured
to output the information in a case where the plurality of users and the reserving person of the service do not match each other at all, and
not to output the information in a case where the plurality of users and the reserving person of the service partially match each other.

13. The information processing apparatus according to claim 11,
wherein the processor is configured
not to output the information in a case where the service is a service to be shared by the plurality of users and the plurality of users and the reserving person of the service partially match each other.

14. The information processing apparatus according to claim 11,
wherein the processor is configured to
output the information in a case where the service is a service to be separately provided to the plurality of users, even in a case where the plurality of users and the reserving person of the service partially match each other.

15. The information processing apparatus according to claim 11,
wherein the processor is configured to
control the reservation of the location or the service such that the plurality of users and the reserving person of the service completely match each other in a case where the plurality of users and the reserving person of the service do not partially match each other.

16. The information processing apparatus according to claim 1,
wherein the processor is configured to
output the information in a case where a first reserving person of a first location and a second reserving person of a second location belong to an identical group and a reserving person of a service to be used at the first location and the second location and the first reserving person and the second reserving person do not match each other.

17. The information processing apparatus according to claim 16,
wherein the service includes providing software for communication between the first location and the second location.

18. The information processing apparatus according to claim 1,
wherein the service includes providing an instrument.

19. The information processing apparatus according to claim 1,
wherein the reservation of the location and the reservation of the service are managed by different reservation management devices.

20. A non-transitory computer readable medium storing a program causing a computer to execute a process comprising:
outputting, in a case where a person who has a reservation of a location and a person who has a reservation of a service to be used at the location do not match each other, information indicating that such reserving persons do not match each other.
